(19) United States
(12) Patent Application Publication
(10) Pub. No.: US 2012/0132020 A1
(43) Pub. Date: May 31, 2012

(54) STEERING DEVICE

(75) Inventors: Peter Kunsch, Karlskron (DE); Wolfgang Schmid, Freising (DE)

(73) Assignee: Audi AG, Ingolstadt (DE)

(21) Appl. No.: 13/302,646

(22) Filed: Nov. 22, 2011

(30) Foreign Application Priority Data
Nov. 25, 2010 (DE) 10 2010 052 546.4

(51) Int. Cl. B62D 3/02; B62D 1/02

(52) U.S. Cl. 74/98; 74/96

(57) ABSTRACT

A steering device for a wheeled vehicle having wheels includes a steering element for steering actuation with a predetermined movement path and a predetermined degree of actuation, a conversion device for converting the steering actuation to an output signal for transmission to a steering drive for steering the wheels, a connection device operatively connecting the steering element with the conversion device for transmitting the steering actuation to the conversion device, and limiting means configured to either selectively release the degree of actuation to a first maximum degree of actuation or limit the degree of actuation to a second maximum degree of actuation which is reduced compared to the first maximum degree of actuation.

### CROSS-REFERENCES TO RELATED APPLICATIONS

This application claims the priority of German Patent Application, Serial No. 10 2010 052 546.4, filed Nov. 25, 2010, pursuant to 35 U.S.C. 119(a)-(d), the content of which is incorporated herein by reference in its entirety as if fully set forth herein.

### BACKGROUND OF THE INVENTION

The present invention relates to a steering device for an automobile, in particular for a passenger car.

The following discussion of related art is provided to assist the reader in understanding the advantages of the invention, and is not to be construed as an admission that this related art is prior art to this invention.

Wheel wells in the vehicle with front wheel drive are conventionally designed so as to ensure an unobstructed space with a centrifugal contour when using snow chains. A large unobstructed space reserved only for special situations when snow chains are used is required especially in the front axle region of an automobile, in particular of a passenger car, due to the large steering angles. Contact locations with other components are also the side rail of the vehicle, which is relatively strongly notched in this region due to the centrifugal contour of the snow chain.

Some steering devices have adjustable limiting means so that this space can be used for increasing the wheel angle and/or reducing the turning radius during steering, while preventing the snow chains from colliding with adjacent vehicle components when using the snow chains. These limiting means are integrated in a steering gear box (a conversion device) of the steering device and are constructed to either selectively release the degree of actuation of the steering wheel to a first maximum degree of actuation (if snow chains are not used) or to limit the degree of actuation to a second maximum degree of actuation which is smaller than the first maximum degree of actuation (when snow chains are used). The degree of actuation or steering angle are limited with these limiting means by two mechanical limiting elements disposed on a toothed rack of the steering gear and operated with two electric motors by way of a gear.

In addition to improving the steering characteristic, for example the structure of the side rail can then be designed without a notch in the side rail, thereby advantageously enhancing the stiffness in a crash and reducing the weight.

However, a toothed rack with two electromechanical actuators for mechanically limiting the movement is expensive and heavy, because these actuators must be present in duplicate (for the right and the left side) and may come into direct contact with dirt and water. Moreover, the installation space in this region may be very tight, which may increase the design complexity.

It would therefore be desirable and advantageous to address this problem and to obviate other prior art shortcomings by providing a steering device with limiting means that are light-weight and better protected from the environment

### SUMMARY OF THE INVENTION

According to one aspect of the present invention, a steering device for a vehicle with wheels includes: a steering element for generating a steering actuation having a predetermined movement path and a predetermined degree of actuation; a conversion device configured to convert a steering actuation transmitted to the conversion device via an input, so that the converted steering actuation, e.g. with a different movement path, can be obtained on an output of the conversion device to be operatively connected to a steering drive for the wheels; a connection device operatively connecting the steering element with the input of the conversion device for transmitting the steering actuation to the conversion device; and limiting means arranged on the connection device and configured to either selectively release the degree of actuation to a first maximum degree of actuation different from zero limit or to limit the degree of actuation to a second maximum degree of actuation which is reduced compared to the first maximum degree of actuation and different from zero. The limiting means may be integrated in the connection device, and even fully integrated in the connection device.

By arranging or integrating the limiting means on or in the connection device which is inherently located closer to the steering wheel and hence farther away from the wheels and the regions exposed to dirt, the limiting means are better protected from environmental factors.

A maximum degree of actuation different from zero is to be understood within the context of the invention such that the steering element is actually moved to a maximum steering angle and is not blocked against actuation, for example by a steering lock.

According to an advantageous feature of the present invention, the steering element may be in form of a steering wheel, as is the case in conventional automobiles, in particular passenger cars. Other forms of a steering element are also feasible, for example a motorcycle-like handlebar. With these forms of steering elements, the steering actuation has a rotative motion.

However, according to the invention, forms of steering elements are also feasible where the steering actuation has a linear motion.

The conversion device is preferably configured to convert a rotative motion of a steering element actuation into a linear motion, or alternatively a linear motion of a steering actuation into a rotative motion.

According to one advantageous feature of the present invention, the conversion device may be configured to convert a rotative motion of a steering actuation to a linear motion of the steering actuation and is formed by a conventional steering gear arrangement typically provided in conventional automobiles, in particular passenger cars.

Alternatively, the conversion device may be configured to convert a rotative motion of a steering actuation to an electric signal, which can be obtained at the output of the conversion device, for example from electric actuators on the wheels, for steering actuation.

According to one advantageous feature of the present invention, the limiting means may have a single limiting element for attaining the limiting/release action, which may be selectively switched either into a release position in which the limiting means realize the first maximum degree of actuation, or into a limiting position where the limiting means realize the second maximum degree of actuation.

According to another advantageous feature of the present invention, the limiting means may have a single actuator element which is drivingly connected with the limiting element, so that by controlling the actuator element the limiting element can be moved selectively between the release position and the limiting position.

By providing only a single limiting element and a single actuating element, the steering device has an overall simpler and lighter structure and can thus be produced more cost-effectively.

According to another advantageous feature of the present invention, the steering element may be configured to generate the steering actuation with a rotative motion, wherein the limiting element is configured to release a rotative motion produced by the steering actuation in the release position and to limit a rotative motion in the limiting position.

This embodiment of the invention has particular advantages when the invention is used, for example in an automobile steered with a steering wheel, such as a passenger car. By limiting the rotative motion, the limiting means can be arranged in close proximity on the steering member and thus also in the passenger compartment which is protected from the environmental effects, while taking up little space.

According to another advantageous feature of the present invention, an additional conversion device may be provided which is integrated in the limiting means and which is configured to convert the second maximum degree of actuation to a rotation of less than 360° (angular degrees).

The inventors have determined that modern steering systems typically have 2.7 revolutions from one end stop to the other end stop. The inventors have realized on this basis that by converting these almost 1000° (angular degrees) of the steering element to less than one complete revolution (360°) in the limiting means, only a single limiting element and a single actuating element would be needed.

According to an advantageous feature of the present invention, the limiting element may be configured for translatory movement between the release position and the limiting position.

A translatory movement can be technically easily implemented, for example by linearly guiding the limiting element in conjunction with a solenoid as an actuator. In addition, a limiting element which can be moved in this way advantageously “snuggles” with very little space required to a connection device that transmits a rotative steering actuation.

Along the same lines, according to another advantageous feature of the present invention, the connection device may include a steering column with a longitudinal axis, wherein the limiting element may be configured to be moved parallel to the longitudinal axis of the steering column between the release position and the limiting position.

Alternatively, the limiting element may also be configured for displacement perpendicular to the longitudinal axis of the steering column (i.e., radially in relation to the steering column) between the release position and the limiting position.

According to another advantageous feature of the present invention, the connection device may include a steering shaft configured to transmit the steering actuation through rotation, wherein the limiting means may include a first rotation transmission element which is arranged (e.g. formed or attached) on the steering shaft so as to rotate with the steering shaft, and a second rotation transmission element which is rotatably supported and supported, for example, on a stationary element, such as a support of the steering column, and which is in rotation-transmitting connection with the first rotation transmission element, wherein the two rotation transmitting elements realize a rotation transmission ratio such that the second maximum degree of actuation is converted to a rotation of less than 360° (angular degree) of the second rotation transmission element.

In other words, the two rotation transmitting elements advantageously form the additional conversion device in a space-saving manner, which is configured to convert the second maximum degree of actuation to a rotation of less than 360°.

According to yet another advantageous feature of the present invention, the second rotation transmission element may have a limit stop which is arranged such that the rotation of the second rotation transmission element is limited by the limiting element in its limiting position to less than 360° (angular degree) and is released in its release position.

The limit stop may be formed on the second rotation transmission element or attached to the second rotation transmission element. By increasing or decreasing a circumferential width of the limit stop (i.e., in the rotation direction of the second rotation transmission element), the second maximum degree of actuation can be decreased or increased and thus optimally matched.

According to another advantageous feature of the present invention, the first rotation transmission element may constructed as a gear wheel with teeth arranged on the outer circumference of the steering shaft, wherein the second rotation transmission element may then be constructed as a hollow gear wheel with teeth arranged on its inner circumference and meshes with the first rotation transmission element, wherein the steering shaft extends through the second rotation transmission element.

This embodiment of the invention supports in a particularly advantageous manner the space-saving design of the limiting means.

According to another advantageous feature of the present invention, the limit stop may be arranged on the inner circumference of the second rotation transmission element, wherein the limiting element may then be arranged radially within a circle circumscribed by the inner circumference of the second rotation transmission element.

This embodiment of the invention advantageously also supports the design of the limiting means with additional space savings.

Alternatively, the limit stop may also be arranged on an outer circumference of the hollow tooth wheel, wherein the limiting element is arranged outside the circle circumscribed by the inner circumference of the hollow tooth wheel. In this case, the limiting element may be constructed for movement parallel to the longitudinal axis of the steering column between the release position or the limiting position, or may alternatively be configured for movement perpendicular to the longitudinal axis of the steering column (i.e., radially with respect to the steering column) between the release position and the limiting position.

In summary, the embodiments of the invention have, inter alia, the following advantages:
Only a single limiting element (e.g., a locking pin which is guided in a limiting slot with a stop) and a single actuating element are required.
The limiting means are smaller, lighter and more cost-effective.
The limiting means are not in direct contact with dirt and water, because they can be integrated in the stalk on the steering column.
The failure rate of the system is reduced by using a single actuating member and a single limiting member.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematically illustrated steering device according to an embodiment of the invention;

FIG. 2 shows a cross-sectional view of a steering column of the steering device of FIG. 1; and

FIG. 3 shows a longitudinal cross-sectional view of the steering column of the steering device of FIG. 1.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

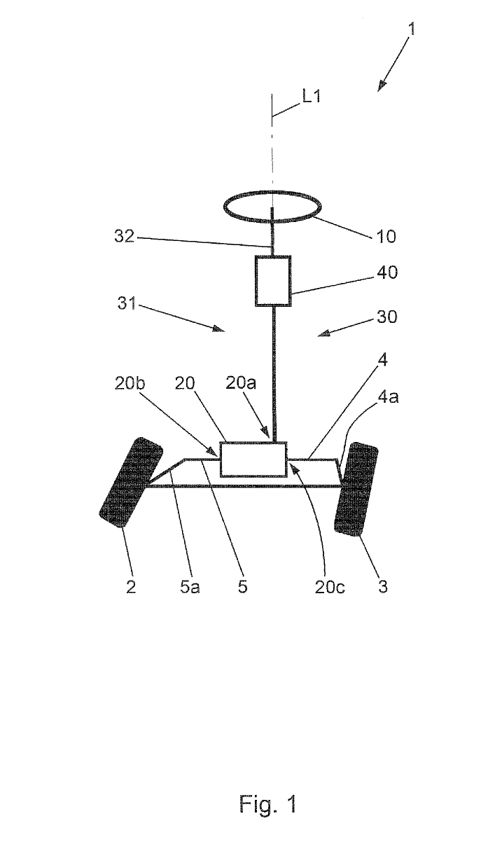

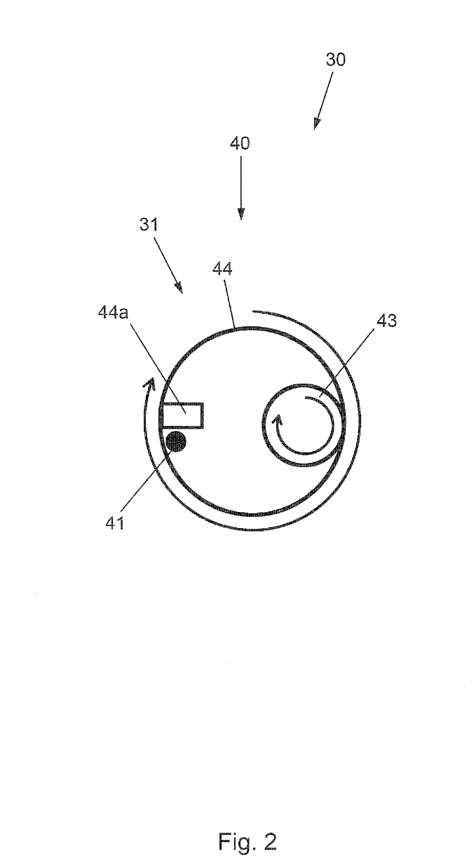

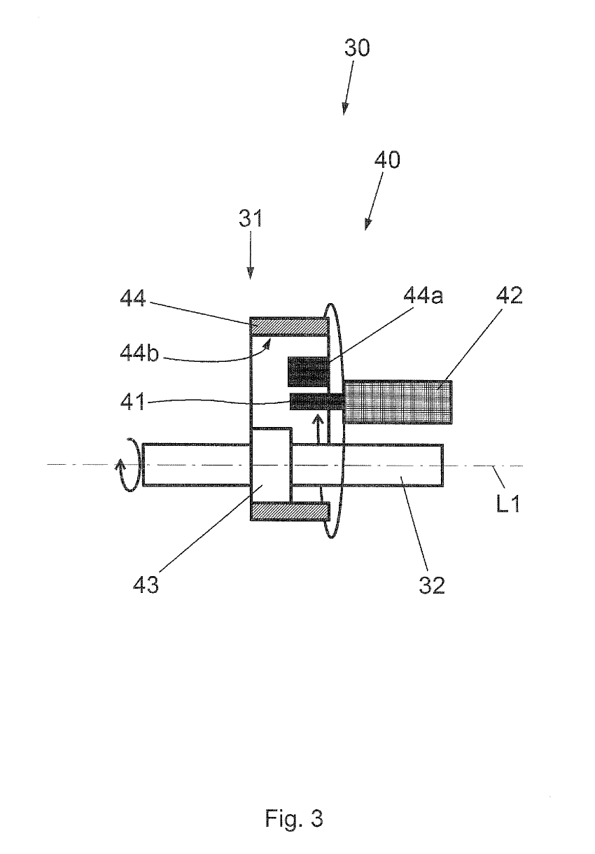

Turning now to the drawing, FIGS. 1 to 3 show an embodiment of a steering device 1 for a vehicle having wheels 2, 3 according to the invention. The steering device 1 is preferably integrated in a passenger car (not completely shown) with front-wheel-drive and four wheels 2, 3.

As shown in FIG. 1 to FIG. 3, the steering device 1 has a steering element 10 implemented as a steering wheel, a first conversion device 20 constructed as a steering gear, a connection device 30, and limiting means 40.

The steering element 10 is used to generate by an operator a steering actuation of the vehicle having a rotative motion and a predetermined degree of actuation (here a predetermined angle in degrees of a rotative actuation of the steering element).

The conversion device 20 is constructed in form of an integrated toothed rod-gear wheel connection (not illustrated) to convert the steering actuation supplied to the conversion device 20 via an input 20a, so that the steering actuation with a linear motion can be obtained at an output 20b, 20c of the conversion device 20 which can be operative connected with the wheels for steering.

In the illustrated embodiment of the invention, the toothed rod of the toothed rod-gear wheel connection of the conversion device 20 is connected as output 20b, 20c on both sides with a respective tie rod 4, 5 of a steering linkage of the vehicle. The two tie rods 4, 5 are in turn each connected via a steering arm 4a, 5a of the steering linkage with a knuckle or wheel carrier (not shown in detail) of the associated steered wheel 2, 3 (front wheel).

The connection device 30 operatively connects the steering element 10 with the input 20a of the conversion device 20, so that the rotative steering actuation can be transmitted to the conversion device 20.

The connection device 30 includes a steering column 31, in which a rotatably supported steering column 32 which is operatively connected to the steering element 10 and has a longitudinal axis L1 is integrated. The connection device 30 is thus configured to transmit the steering actuation through the rotation of the steering shaft 32.

The limiting means 40 are arranged on the connection device 30 and are, according to this embodiment, integrated in the connection device 30 and configured to either release the degree of actuation of the rotative steering actuation selectively to a first maximum degree of actuation (if snow chains are not used) or to limit the degree of actuation to a second maximum degree of actuation which is reduced compared to the first maximum degree of actuation (when snow chains are used).

The limiting means 40 include a single limiting element 41 to be actuated in form of a locking pin supported for linear movement and a single actuating element 42 in form of a solenoid or electromagnet for realizing a linear actuating motion, wherein the actuating element 42 is drivingly connected with the limiting element 41.

The limiting element 41 can be selectively moved by electrically controlling the actuating element 42 (e.g., with an electric switch installed in the passenger compartment) between a release position (not shown in the figures) in which the limiting element 41 is completely retracted into the actuating element 42 and thereby releases the first maximum degree of actuation, and a limiting position (as shown in the figures) in which the limiting element 41 is extended from the actuating element 42, thereby limiting the degree of actuation to the smaller second maximum degree of actuation. In other words, the limiting element 41 is configured for translatory movement parallel to the longitudinal axis L1 of the steering shaft 32 of the steering column 31 between the release position and the limiting position.

As mentioned above, according to a variant not illustrated in the figures, the limiting element 41 could alternatively be constructed so as to perform a translatory movement perpendicular to the longitudinal axis L1 of the steering shaft 32 of the steering column 31 between the release position and the limiting position.

The limiting means 40 further include a first rotation transmission element 43 which is attached to the steering shaft 32 with a rotation lock, and a second rotation transmission element 44 which is rotatably supported on a stationary element, for example an unillustrated support of the steering column 31, and which is connected for rotation with the first rotation transmission element 43.

The two rotation transmission elements 43, 44 realize a rotation transmission ratio, such that the second maximum degree of actuation is converted to a rotation of the second rotation transmission element 44 of less than 360°.

It was determined by the inventors that modern steering systems typically have 2.7 revolutions (972°) from one end stop to the other end stop. The inventors have recognized on this basis that by converting these 972° (angular degrees) of the steering element 10 to less than a complete revolution (360°) in the limiting means 40, only a single limiting element 41 and a single actuating element 42 would be required.

The two rotation transmission elements 43, 44 thus form a second conversion device configured to convert the second maximum degree of actuation to a rotation of less than 360° in the limiting means 40.

The second rotation transmission element 44 has a limit stop 44a formed thereon, which is arranged to limit the rotation of the second rotation transmission element 44 with the limiting element 41 in its limit position to less than 360° and to release the second rotation transmission element 44 in the release position.

The limiting element 41 is thus configured to release a rotative motion of the second rotation transmission element 44 generated by the steering actuation in the release position and to limit the rotative motion in the limiting position.

In other words, when the limiting element 41 is in the extended limiting position (as illustrated in the figures), the limit stop 44a strikes the limiting element 41 when the wheels 2, 3 are turned, thereby preventing further turning or a larger degree of actuation and thus realizing the reduced second maximum degree of actuation of the steering actuation of the steering element 10.

Conversely, wherein the limiting element 41 is in the retracted release position, the second rotation transmission element 44 can turn beyond 360° without restraint, so that limit stop defining the first maximum degree of actuation of the steering actuation of the steering element 10 is not realized by the limiting means 40, but instead by, for example, the first conversion device 20 (steering gear).

The first rotation transmission element 43 is constructed as a gear wheel with teeth (not shown in detail) arranged on the outer circumference of the steering shaft. The second rotation transmission element 44 is constructed as a hollow gear wheel with teeth (not shown in detail) arranged on an inner circumference 44b of the hollow gear wheel and is in rotation-transmitting tooth engagement with the first rotation transmission element 43, with the steering shaft 32 extending through the hollow gear wheel.

The limit stop 44a is arranged on the inner circumference 44b of the second rotation transmission element 44, wherein the limiting element 41 and the actuating element 42 are arranged radially within a circle circumscribed by the inner circumference 44b of the second rotation transmission element 44.

As mentioned at the beginning, according to one variant not illustrated in the figures, the limit stop 44a may be arranged on an outer circumference of the second rotation transmission element 44, wherein the limiting element 41 and the actuating element 42 are arranged outside the circle circumscribed by the inner circumference 44b of the second rotation transmission element 44.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A steering device for a vehicle having wheels, comprising:
a steering element for generating a steering actuation having a predetermined movement path and a predetermined degree of actuation,
a conversion device configured to convert the steering actuation received at an input of the conversion device to a converted steering actuation at an output of the conversion device which is connected to a steering drive for the wheels,
a connection device operatively connecting the steering element with the input of the conversion device for transmitting the steering actuation to the conversion device, and
limiting means arranged on the connection device and configured to either selectively release the degree of actuation to a first maximum degree of actuation or to limit the degree of actuation to a second maximum degree of actuation which is reduced compared to the first maximum degree of actuation.

2. The steering device of claim 1, wherein the limiting means comprise a limiting element having a release position and a limiting position, wherein the limiting element can selectively assume either the release position, in which the limiting means realize a first maximum degree of actuation, or the limiting position, in which the limiting means realize the second maximum degree of actuation.

3. The steering device of claim 2, wherein the limiting means comprise an actuating element which is drivingly connected with the limiting element, wherein control of the actuating element allows the limiting element to selectively move between the release position and the limiting position.

4. The steering device of claim 2, wherein the steering element is constructed to generate the steering actuation with a rotative motion, and wherein the limiting element releases the rotative motion in the release position and limits the rotative motion in the limiting position.

5. The steering device of claim 4, further comprising an additional conversion device which is integrated in the limiting means and configured to convert the second maximum degree of actuation to a rotation of less than 360°.

6. The steering device of claim 2, wherein the limiting element is configured for translatory movement between the release position and the limiting position.

7. The steering device of claim 2, wherein the connection device comprises a steering column having a longitudinal axis, and wherein the limiting element is configured for movement parallel to the longitudinal axis of the steering column between the release position and the limiting position.

8. The steering device of claim 2, wherein the connection device comprises a steering shaft configured to transmit the steering actuation through rotation, wherein the limiting means comprises a first rotation transmission element arranged on the steering shaft for co-rotation with the steering shaft and a second rotation transmission element which is rotatably supported and which is in rotation-transmitting connection with the first rotation transmission element, wherein the two rotation transmitting elements realize a rotation transmission ratio such that the second maximum degree of actuation is converted to a rotation of the second rotation transmission element of less than 360°.

9. The steering device of claim 8, wherein the second rotation transmission element has a limit stop which is arranged such that the rotation of the second rotation transmission element is limited by the limiting position of the limiting element to less than 360° and is released in the release position of the limiting element.

10. The steering device of claim 8, wherein the first rotation transmission element is constructed as a gear wheel with teeth arranged on an outer circumference of the steering shaft, wherein the second rotation transmission element is constructed as a hollow gear wheel with teeth arranged on an inner circumference of the hollow gear wheel and meshing with the teeth of the first rotation transmission element, wherein the steering shaft passes through the second rotation transmission element.

11. The steering device of claim 10, wherein the limit stop is arranged on the inner circumference of the second rotation transmission element, wherein the limiting element is arranged radially within a circle circumscribed by the inner circumference of the second rotation transmission element.
